(19) United States
(12) Patent Application Publication
(10) Pub. No.: US 2005/0220946 A1
(43) Pub. Date: Oct. 6, 2005

(54) Coated food product, composition, method and apparatus for making same

(75) Inventor: Philippe Torcatis, Reze (FR)

Correspondence Address: COHEN, PONTANI, LIEBERMAN & PAVANE, 551 FIFTH AVENUE, SUITE 1210, NEW YORK, NY, 10176, US

(73) Assignee: PALGA INTERNATIONAL, Avignon (FR)

(21) Appl. No.: 10/501,486

(22) PCT Filed: Jul. 25, 2003
(86) PCT No.: PCT/FR03/02348

§ 371 Date: Jul. 13, 2004

(30) Foreign Application Priority Data
Jul. 26, 2002 (FR) 02/209479

(51) Int. Cl. A23C 1/00

(52) U.S. Cl. 426/315

(57) ABSTRACT

The technical field of the invention is that of manufacturing apparatuses for automatically making sausages. The present invention relates to a coated food product, in particular a sausage, to a composition for coating the food product, to a method of coating food products, and to apparatus enabling the method to be implemented. The method comprises in succession the following steps: a sausage of raw sausage meat, purée , or paste is molded by being passed through a tubular mold; the mold is cut up into segments having ends that are preferably rounded; the segments are moved while being covered in a first composition containing sodium alginate so as to coat the segments in a film of this first composition; and the coated segments are put into contact with a second composition containing a calcium salt in order to cause a gel of calcium alginate to be formed, coating the segments.

The present invention relates to a coated food product, in particular a sausage, to a composition for coating a food product, to a method of coating food products, and to apparatus enabling the method to be implemented.

The technical field of the invention is that of providing apparatuses for making sausages automatically.

### BACKGROUND OF THE INVENTION

It is known to make sausages by enclosing the meat in a skin; the use of skins made of natural intestines of animal origin is objectionable because of the risk of transmitting diseases, in particular infectious diseases attributed to prions; the use of synthetic skins requires the food products to be subjected to heat treatment, followed by separation (or peeling) of the skin and the meat, and it spoils the appearance of the resulting food products.

A method of making skinless sausages is known from published patent EP 0 029 806, in which tubular molds are filled with meat, the meat is heated in the mold to coagulate the surfaces of the sausages, and then the sausages are ejected from the molds: that method requires complex equipment and presents productivity that is relatively low; in addition, the use of heat treatment alters the organoleptic properties of the meat.

### OBJECTS AND SUMMARY OF THE INVENTION

An object of the invention is to propose an improved method of making sausages and similar food products, and to propose apparatus that is simple for implementing the method.

An object of the invention is to propose a food product that is shaped and/or molded, being essentially constituted by sausage meat, purée , or a pasty and/or fibrous mixture, generally raw, presenting mechanical characteristics that enable it to be manipulated without being cased in a skin.

In a first aspect, the invention consists in coating and/or covering the food product in a composition that has no extracts of animal origin, that does not melt on being cooked, and that contributes to the cohesion of the product.

Preferably, the gelled composition coating the product includes calcium alginate; it has been found that this substance based on extracts from seaweed, makes it possible in accordance with the invention, to improve the cohesion and the mechanical strength of the meat that it coats without becoming mixed therewith; the coating also makes it possible to prevent the coated products from sticking together, making them easier to manipulate.

Also preferably, the composition in which the food product is covered includes proteins of vegetable origin, dextrose and maltodextrin, which enable the behavior of the food product to be improved during cooking.

Preferably, coating is performed in two successive steps: initially the food product is covered in a film of a first aqueous composition—in particular water—having dispersed therein powdered sodium alginate together with proteins, sugars, and/or starch, and then the essentially liquid film is caused to harden by putting the film-covered product into contact with a second aqueous composition containing a calcium salt; this salt, in particular calcium chloride, reacts with the sodium alginate present in the film covering the food product in order to form a calcium alginate gel which provides the food product with cohesion without it being necessary to subject it to heat treatment; the gel formed in this way around the meat withstands cooking heat.

In a preferred implementation, the covering of the food product with the first composition containing sodium alginate comprises a step of coating the food product by immersing it in a first bath, and the step of putting the product into contact with the second composition containing a calcium salt also comprises a step of immersion, in a second bath; also preferably, the immersion of the product in the first bath is preceded, associated with, and/or followed by the product being sprinkled by the first composition containing sodium alginate.

The content of the first composition in proteins, dextrose and maltodextrin is selected in particular so as to adjust the fluidity of this composition, as a function of the technical characteristics of the equipment for implementing the method, in particular to make the composition easier to pump, to circulate, and to spray. The contents of these substances are also selected so as to adjust the coating rate (and/or thickness) and the solidity (cohesion) of the finished product, and to ensure that it behaves well during cooking in terms of shrinking and coloring.

According to other preferred characteristics of the invention:

the sodium alginate is in the form of a powder dispersed in an aqueous solution, the composition presenting fluidity that is high enough to enable it to be transported under drive from a pump and to enable it to be sprayed via nozzles to sprinkle the products that are to be covered; preferably, the covering composition is sprayed onto the products in distributed manner by forming a curtain;

the proportion by weight of the sodium alginate in the first composition lies in the range 0.5% to 2%;

the proportion by weight of the calcium salt in the second composition lies in the range 0.1% to 15%.

Preferably, the method of the invention comprises the following steps in succession:

making a sausage of sausage meat, purée , or paste by causing it to pass through a tubular mold;

cutting the sausage into segments preferably having ends that are rounded;

moving the segments while covering them in a first composition containing sodium alginate, so as to coat the segments in a film of the first composition; and

putting the coated segments into contact with a second composition containing a calcium salt so as to cause a layer of calcium alginate gel to be formed that coats the segments.

Preferably, the sausage cutting tools are wetted with said first composition in order to lubricate them.

Preferably, the food products are immersed in succession in two baths of said first and second compositions, respectively, the products are wetted (sprinkled) with the first composition, and the surface distribution of the first composition on the covered products is modified by draining, preferably associated with the action of jets of air in order to improve and homogenize the quality of the covering by said first composition, prior to the products being immersed (and/or sprinkled and/or wetted) in said second composition.

According to another aspect, the invention provides a method of making molded food products based on fibrous sausage meat (purée or paste), by passing the meat through a tubular mold, to form an extruded sausage, in which method the sausage is caused to contract and then to expand, the contraction being sufficient to cause at least a portion of the fibers of the fibrous meat to take up a transverse orientation, so that during cooking of the product, the contraction of the fibers encourages a reduction in the diameter of the food product instead of the product shortening (in its long direction).

A particular result of the invention is to enable food products of a very wide variety of cylindrical and/or tubular shapes to be made automatically.

In another aspect, the invention provides apparatus for making food products from fibrous sausage meat (or purée or paste), in particular apparatus enabling the above-defined method to be implemented, the apparatus comprising a preferably tubular mold and means for introducing meat into the mold in order to form a sausage of meat, which means preferably include moving separator means for separating the sausage into segments, and covering means for coating the segments of meat in a gelling composition.

The apparatus preferably comprises a first vessel suitable for containing a first bath of a first composition for coating the products, and a second vessel suitable for containing a second bath of a second composition for coating the product, and means for transporting the segments so as to transport the segments from the first vessel to the second vessel.

In another aspect, the invention provides apparatus including means for introducing the gelling composition into the proximity of the moving separator means (and in particular ejection nozzles and/or transport channels), preferably upstream therefrom, so that said composition contributes to limiting or preventing adhesion of the meat on the moving separator means, to reducing friction between said moving means, and to facilitating regular shaping of the segments, and in particular of their ends.

In another aspect, the invention provides apparatus comprising a plurality of tubular molds or nozzles enabling a plurality of meat sausages to be formed simultaneously, and a plurality of moving shaping and cutting means associated respectively with the tubular molds and enabling the sausages to be separated simultaneously into segments.

According to preferred characteristics of the invention:

said apparatus includes means for distributing meat amongst the tubular molds, which meat is delivered via a meat feed orifice; these means for distributing—or sharing—meat preferably comprise a rotary structure defining a distribution cavity communicating with the tubular molds and also with the meat feed orifice; this rotary structure preferably presents an outside surface having rotary drive means, in particular an outside surface including teeth suitable for meshing with a drive member such as a gearwheel; the distribution cavity preferably presents symmetry about the axis of rotation of the rotary structure; the meat feed orifice is centered substantially on said axis of rotation, and the meat outlet orifices through which the distribution cavity communicates with the tubular molds extend symmetrically about said axis (e.g. being centered on the three vertices of an equilateral triangle whose center is situated on the axis, when the apparatus has three tubular molds), so as to encourage balanced distribution of the meat delivered by the feed orifice to the tubular molds.

In another aspect, the invention provides apparatus in which the molds are parallel and in substantially horizontal alignment so as to encourage segments of meat sausage to exit in line with a conveyor belt taking the segments delivered by the separator means to the inlet of the covering means (by immersion and sprinkling).

Also preferably:

the tubular mold(s) is/are fixed to a separator and shaping structure (or head) and to a meat pushing (feeding) unit via removable connection means making it easier to disassemble the mold(s) for cleaning and/or exchange purposes;

the apparatus comprises a frame supporting a segment separator and shaping structure (or head) and means for distributing meat to the tubular molds, in particular said rotary structure, which frame is adjustable and deformable, in particular being telescopic, so as to facilitate fitting and removing the tubular molds and/or the meat distribution means; and

said apparatus further comprises means for homogenizing the film or layer of the first composition coating the product, which means are preferably disposed between said first and second vessels, said means preferably comprising a moving support (such as a conveyor belt) that is perforated so as to enable the products to drain, and/or nozzles for blowing air or a suitable gas.

In another aspect, the invention provides apparatus in which the moving separator means comprise blades mounted to move in reciprocating translation on a segment separator and shaping structure (or head) so as to form a guillotine, the end of each of the blades being shaped firstly, to separate the sausage into segments while in a first relative position in which they are closed, and secondly to shape an end of a segment of meat sausage while in a second relative position in which they are partially open.

Each of the blades preferably includes a semicircular notch, with the edge of the notch tapering to form a cutting edge.

The apparatus preferably includes two actuators for driving the two blades respectively, a control unit suitable for controlling the operation of the actuators and also the operation of the means for introducing meat into the mold, the control unit including means for controlling the two actuators individually and means for controlling the introduction means so as to cause the meat to pass through an orifice defined by the blades when the blades are in a position for partially closing the tubular mold, and for causing the section of a segment of sausage in the vicinity of its end to decrease progressively.

The individual control of the actuators driving the shaping and cutting blades makes it easier to round the ends of the segments of sausage by controlling the phase offset between the movements of the blades.

The blades are preferably lubricated by the first covering composition.

The apparatus preferably includes means for constricting the flow of sausage-shaped meat, suitable for causing the orientation of fibers in the meat sausage to be modified, thereby improving the cohesion of the meat sausage.

### BRIEF DESCRIPTION OF THE DRAWINGS

Other characteristics and advantages of the invention appear in the following description which refers to the accompanying drawings, showing preferred embodiments of the invention without any limiting character.

Unless stated to the contrary, identical or similar references are used for designating elements that are identical or similar.

FIG. 1 is a diagrammatic longitudinal side view showing a machine of the invention and its use for making sausages without skins, in a first preferred embodiment.

FIG. 2 is a view similar to FIG. 1, showing a second preferred embodiment of a machine incorporating three tubular segments for molding sausage meat which are fed by means of a rotary distributor.

FIGS. 3A and 3B are longitudinal section views of a system for molding a sausage, for cutting the sausage into segments, and for shaping the ends of the segments, shown in two positions of the cutting system: in FIG. 3A, the cutting blades are close together and close off one end of a molding nozzle, whereas in FIG. 3B, the blades are in an open position allowing all of the sausage leaving the nozzle to pass through.

FIGS. 4A and 4B are face views of the system for cutting and shaping segments, of respectively FIG. 3A and FIG. 3B.

FIG. 5 is a view similar to FIGS. 4A and 4B showing a device for cutting and shaping three meat sausages simultaneously as formed by three nozzles that are in alignment on a horizontal axis.

FIG. 6 is a side view on a larger scale than FIG. 2 showing in particular the system for distributing meat delivered via a single feed duct to three nozzles for forming three sausages simultaneously.

FIG. 7 is a cross-section on a larger scale on a vertical plane marked VII in FIG. 6 showing a rotary distributor and its drive gearwheel.

FIGS. 8A to 8D are face views of two blades of a cutter device of the kind shown in FIGS. 3A, 3B, 4A, and 4B, in four successive relative positions of the blades, illustrating a sequence for cutting a sausage, closing the corresponding molding nozzle, and shaping one end of a segment of sausage.

FIGS. 9A to 9D are section views of the blades in the same respective positions as FIGS. 8A to 8D: these views are respectively on IXA-IXA to IXD-IXD of FIGS. 8A to 8D.

FIG. 10 is a longitudinal section view of a segment of a tubular mold provided with a constriction.

FIG. 11 is a section view of a sausage in accordance with the invention.

FIGS. 12 and 13 show a variant of the apparatus, and show the system for transferring sausages from the first bath to the second; FIG. 12 is a side view, while FIG. 13 is a plan view seen looking along XIII in FIG. 12.

### MORE DETAILED DESCRIPTION

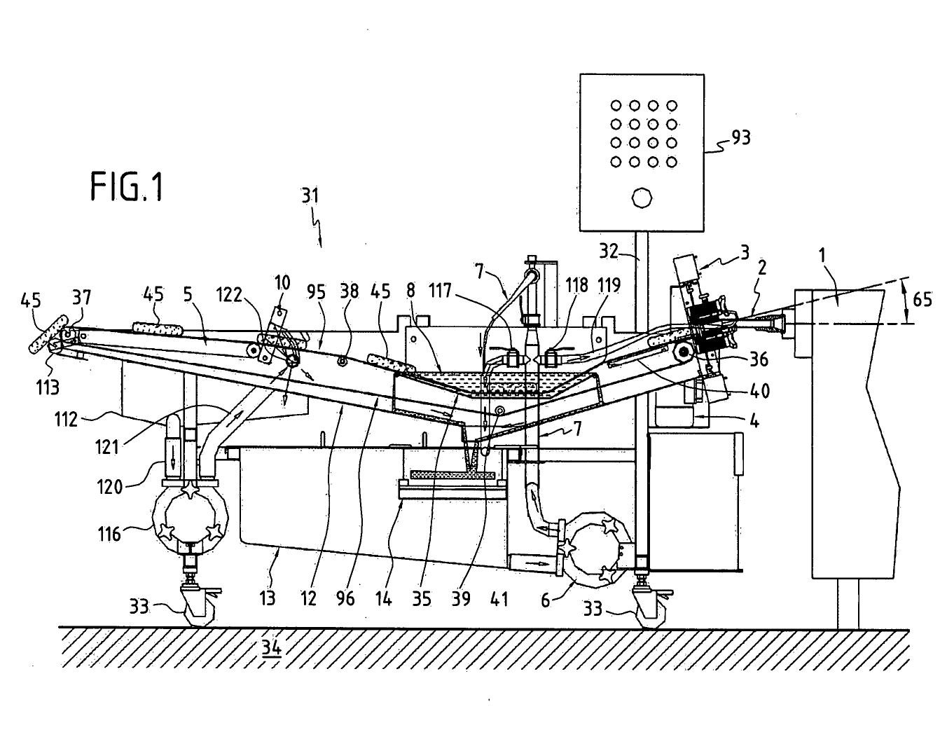

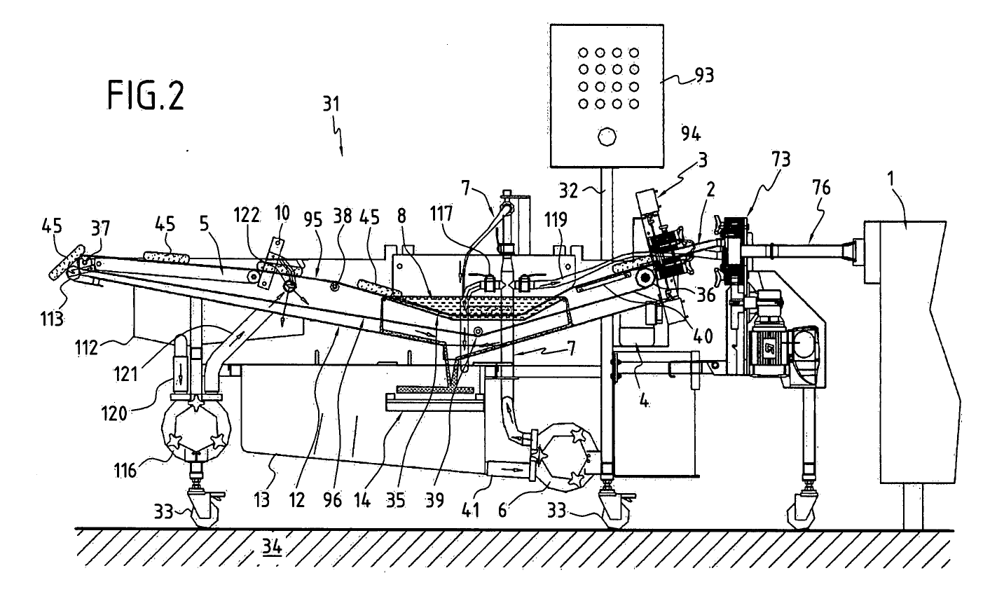

With reference to FIGS. 1 and 2 in particular, the apparatus 31 comprises a frame 32 fitted with wheels 33 standing on the ground 34.

The frame 32 supports three superposed tanks receiving the first coating aqueous composition containing sodium alginate: an overflow tank 35, a collecting tank 12, and a storage tank 13; the frame also supports a fourth tank 112 for preparing the first composition, and a conveyor 5 having a perforated conveyor belt, with a top strand 95 that extends over the tank 35 and a bottom strand 96 that extends under the tank 35, between said tank and the collecting tank 12; a motor 4 drives an end roller 36 of the conveyor in rotation; the belt of the conveyor 5 is guided by a second end roller 37 and by rollers or other intermediate guide devices 38 to 40; these guide means constrain a portion of the conveyor belt to slide along the bottom of the tank 35 so that the sausages 45 resting on the top strand of the belt are immersed (preferably partially immersed) in the composition filling the tank 35.

The apparatus further comprises a pump 6 for circulating the composition which it takes in from the tank 13 via an intake duct 41 and which delivers the composition into a duct that is terminated by a sprinkler strip (or curtain) 7 extending over the tank 35 and/or the top strand of the sausage conveyor belt.

The pump 6 possesses a T-connection on the delivery duct 7 having one side 119 feeding the head 3 and the other forming a bypass 117; the tank 112 is fitted with a fragmentation pump 116 which, via an intake duct 120 and a delivery duct 121, serves to drive circulation around a closed circuit for blending and breaking up lumps; a valve 122 serves either to perform mixing or else emptying of the tank 112 into the tank 12 in order to feed the tank 13 via the filter 14.

The frame of the apparatus also supports a chest 93 containing an electronics unit for monitoring and controlling the actuators of the apparatus, and a device 3, referred to as a “head”, for cutting and shaping individual sausages from a continuous sausage of meat.

The apparatus also includes a tank 42 containing a bath 44 of an aqueous solution of calcium salt; the tank 42 is fitted with an (optional) electrical heater member 43 for precooking the products, and it co-operates with a conveyor 46 for extracting sausages from the bath 44.

The tank 42 is disposed in such a manner as to receive the sausages falling off the downstream end of the conveyor 5; the tank 42 and the conveyor preferably extend transversely relative to the conveyor 5 so that the sausages delivered in line by the conveyor 5 extend side by side (parallel to one another) in the tank 42; the conveyor 46 may be fitted with a perforated belt enabling any excess composition coating the sausages at the outlet from the bath 44 to be drained, in the same manner as with the conveyor 5; the collecting tank 12 extends over the entire length of the conveyor 5 so as to collect not only the solution overflowing from the tank 35, but also the solution that drains off the sausages being carried by the conveyor 5, and the solution that drains off the belt of said conveyor.

A second sprinkler strip spraying the second composition enables the sausages to be covered therein as they pass from the conveyor 5 to the tank 42.

A pusher 1 serves to feed the machine 31 with sausage meat. The pusher 1 possesses a program for portioning and taking connection for the purpose of synchronizing it with the shaping and coating machine.

A feed duct 2, 76 adapted to the pusher ensures that the sausage meat (FIG. 1) is put into a cylindrical sausage shape, or else is fed to the distributor 73 (FIG. 2).

The shaping head serves to cut apart the portions or segments of sausage and to round their ends, and also to implement first coating of the sausage meat; in order to obtain an optimum result, it is preferable for the pusher to be controlled so as to determine its rate of throughput, after which the positions and the travel speeds of the guillotine blades are adjusted.

The conveyor 5, which is adjustable in speed, serves to transfer the separated sausages into the bath 8 of coating substance, which bath is fed by a curtain 7 (FIG. 1) of substance situated above the bath. By overflowing, the coating substance is removed into the storage tank 13 situated beneath the machine, and the pump 6 serves to cause the coating composition to circulate continuously. A filter 14 retains the particles or waste included in the returning coating substance.

The sausage 45 leaving the bath 8 passes through curtains of clean air 10 (or other suitable gas) that are adjustable for the purpose of controlling the thickness of the coating. Thereafter, the product 45 is expelled towards the second end of the line which is a wetter 42 for the second bath 44 of the second solution whose purpose is to cause the first substance to gel.

The tank 112 is fitted with a shearing pump for eliminating lumps associated with mixing water and powder. This pump works in a closed loop and a set of valves serves either to deliver into the storage tank, or else to circulate round a closed loop.

The machine 31 may have different production capacities with the same base. Either the machine uses a shaping and cutting head 3 having a single outlet (FIG. 1), or else a head having two or three or more outlets (FIG. 2). In which case, an intermediate element is used: a sharer 73 (FIG. 2) for sharing and distributing the volume and the weight of the meat in regular manner amongst all of the outlets.

With reference to FIG. 11, the sausage 45 whose meat includes fibers 46 and granules 47 or accumulations of fat is coated in a gelled layer 48 that withstands cooking and that contains the calcium alginate obtained by the sodium alginate reacting with the calcium salt.

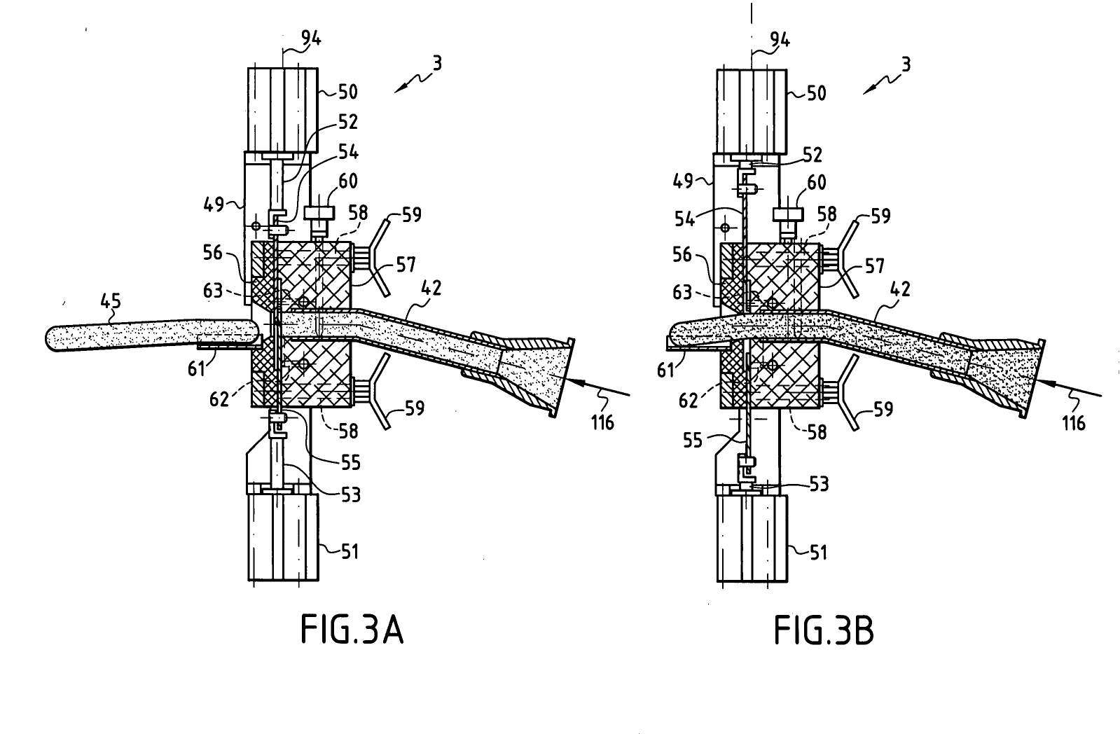

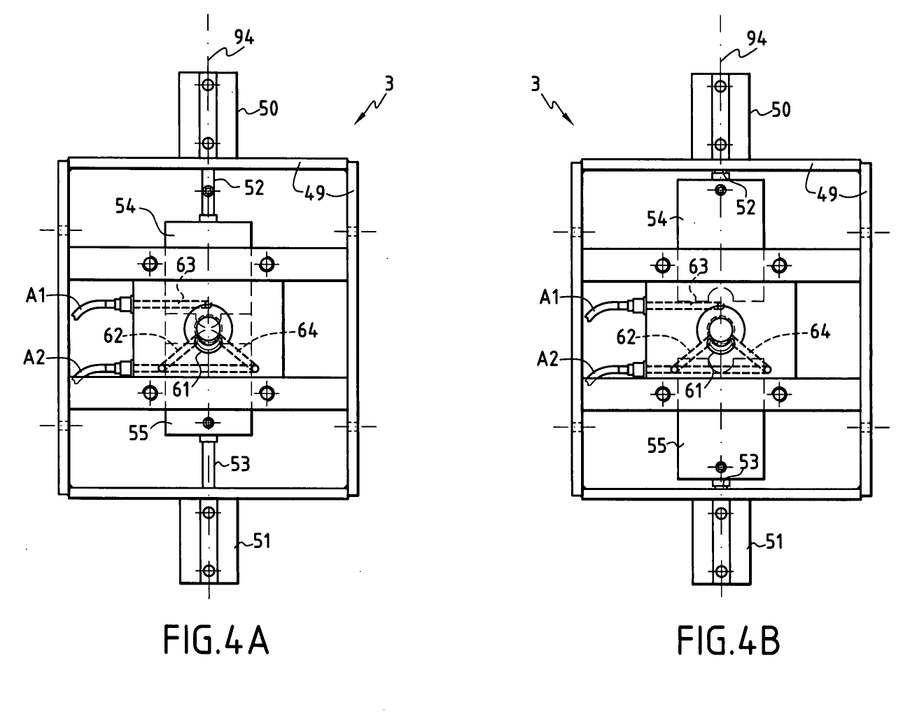

With reference to FIGS. 3A to 4B, the shaping head 3 comprises a frame 49 capable of receiving either a single-outlet tool or a multi-outlet tool. The frame has fixed thereon two pneumatic actuators 50, 51 with respective rods 52, 53 supporting and driving respective top and bottom guillotine blades 54 and 55 in reciprocating movement in translation along an axis 94. For this purpose, each guillotine blade possesses a hole enabling it to receive a support peg fixed at the end of the actuator rod. The guillotine blades are guided by a front plate 56 and a rear block 57, defining two grooves receiving the blades that slide therein. The two parts 56 and 57 are held by four parallel rods 58 secured to the frame 49, each having a threaded end. Butterfly nuts 59 serve to hold the assembly clamped together. A two-pronged fork 60 enables the nozzle 2 to be releasably secured and locked to the block 57 of the shaping device 3. A semicylindrical support 61 (of gutter shape) is fixed to the front plate 56 and serves to hold a sausage as it leaves the head 3: the sausage slides along the support 61 because of the angle of inclination 65 (FIG. 1) of the head 3 relative to the horizontal, and because of the flow of coating substance; the first coating composition is delivered by a pump to the block 57 of the head 3 via two ducts A1 and A2 and it flows in channels 62 to 64 formed in the block 57 and opening out behind the guillotine blades, at three points which are distributed at 120° intervals, in slots where the cutting blades slide.

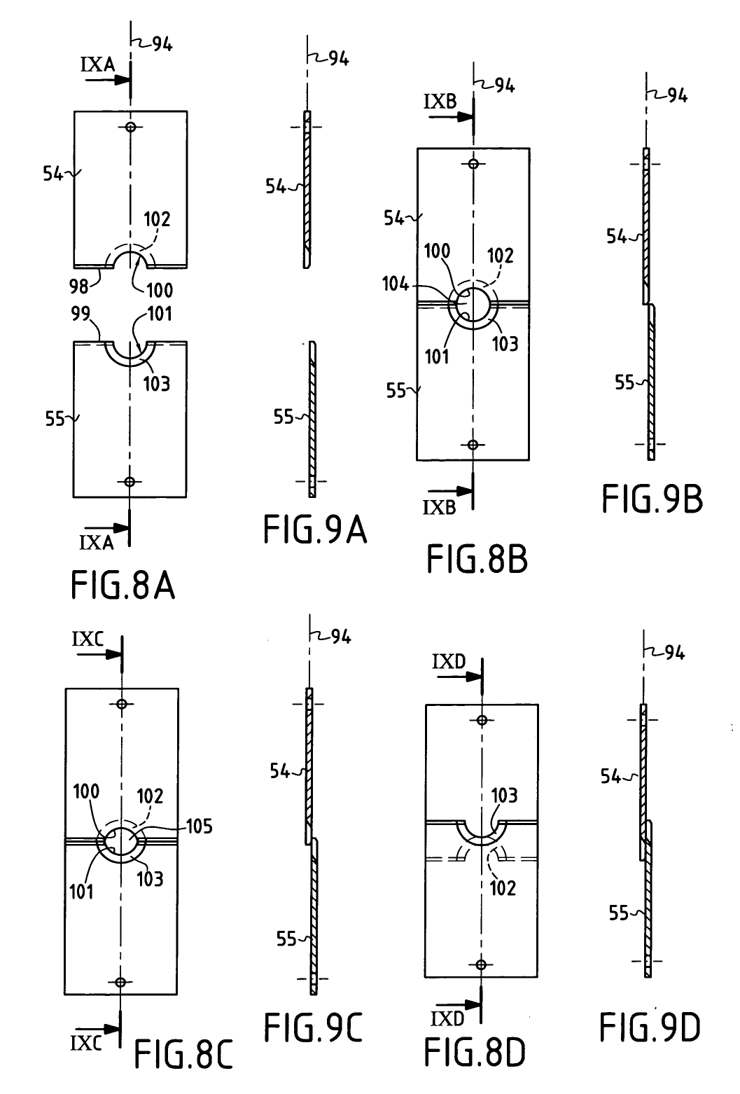

With reference to FIGS. 8A to 8D, cutting is provided by the two guillotine blades converging on each other and by the semicircular chamfer cutout that ensures that the ends of the sausages are rounded.

With reference to FIGS. 8A to 8D, each blade 54, 55 is substantially rectangular in shape, having a chamfered edge 98, 99; a notch 100, 101 of semicircular profile is formed in the central portion of this edge and extends symmetrically on either side of the axis 94 along which the blades move in translation; a chamfer 102, 103 is formed in the blades along each notch 100, 101; FIGS. 8A and 9A show the blades in a position of maximum mutual spacing; FIGS. 8B and 9B show the blades in a position in which the edges 98 and 99 of the blades overlap and in which the two notches 100, 101 together define a circular orifice 104 through which sausage meat can pass and substantially matching the orifice of the meat-shaping mold 2 placed upstream from the blades; FIGS. 8C and 9C show the blades in a position where the notches 100, 101 overlap in part so as to define an orifice 105 of smaller aperture that still enables sausage meat to pass through said orifice; while in this position, the passage of meat therethrough causes an end portion of the segment of sausage to have a section that is smaller than the section which results from the meat passing through the orifice 104 as shown in FIGS. 8B and 9B; FIGS. 8D and 9D show the blades in a closed position where they prevent meat from passing through and enable a segment of sausage to be separated.

With reference to FIG. 5, the three-outlet shaping head has a structure that is similar and operates in a manner that is identical to the single-outlet shaping head, but it is fitted with three outlets and with a network of channels for circulating and delivering the coating substance to each outlet.

The head has two guillotines (top guillotine 54A and bottom guillotine 55A) each having three indentations, each indentation consisting in a semicircular notch of diameter corresponding to the diameter desired for the sausages.

The multi-outlet tooling can be mounted in the position of the single-outlet tooling so as to replace it, using the same support frame 49, thus making it possible to use one or other tool for shaping and cutting on the same machine.

With reference to FIG. 5, the three outlet orifices 66 to 68 of the shaping and cutting head extend along three respective axes 69 to 71 that are orthogonal to the plane of FIG. 5, and that are in alignment along a horizontal axis 72.

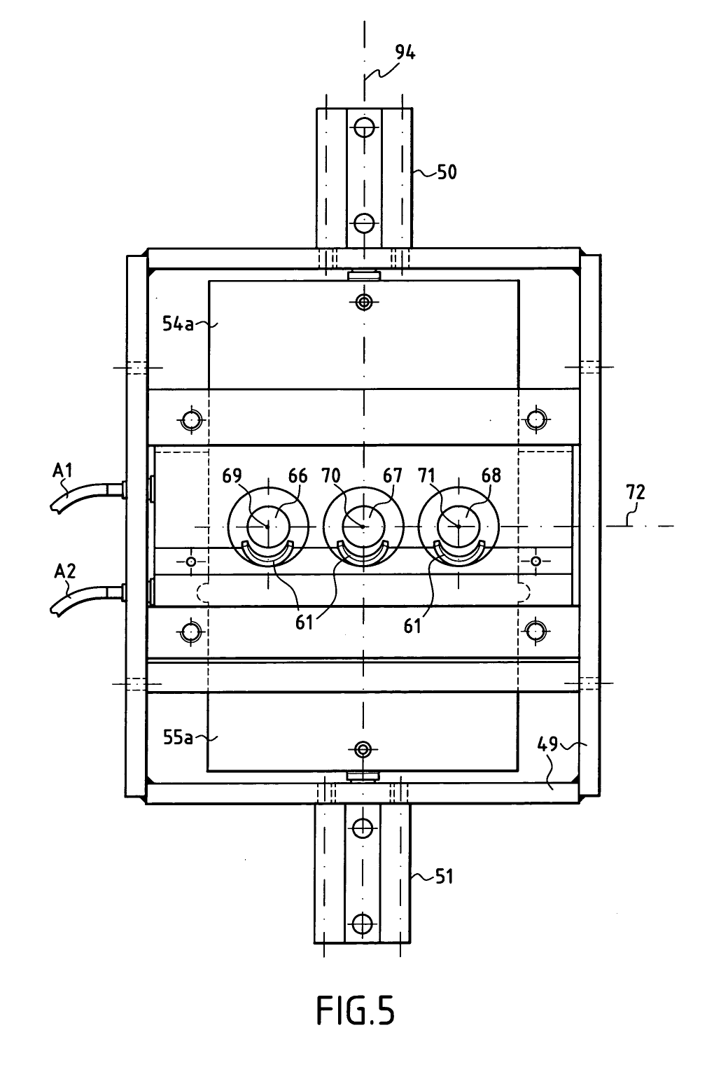

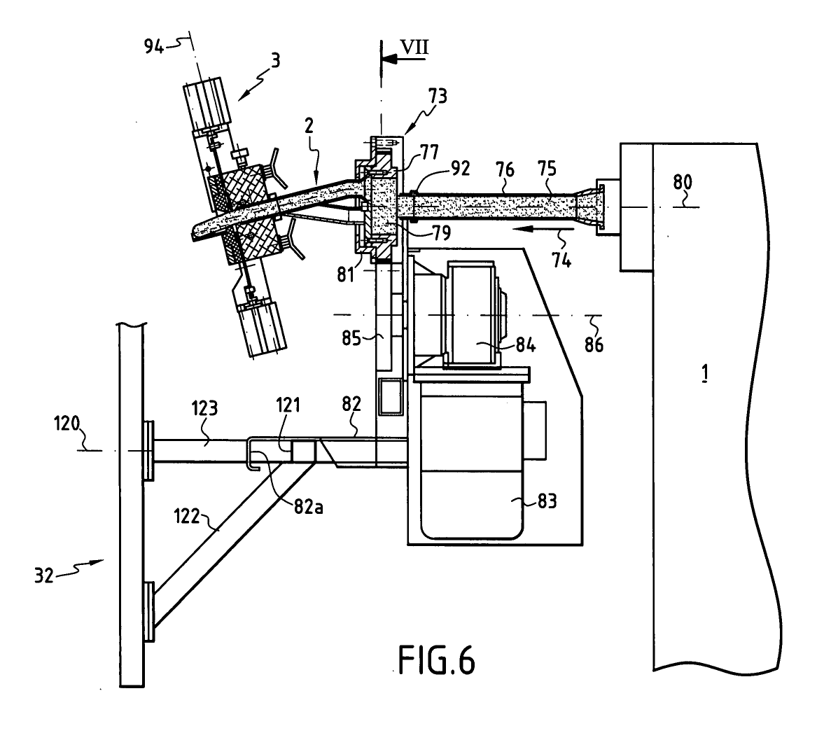

With reference to FIGS. 2, 6, and 7, a distributor 73 serves to share the flow 74 of meat 75 transported in an outlet duct 76 from a meat pusher device 1 towards three tubes or nozzles 2 delivering the molded meat to the inlet of the shaping head 3, as shown in FIG. 5.

The distributor—or sharer—comprises a ring 77 of circular section having an inside face 78 with a wall that defines a cavity 79 that is circularly symmetrical about a horizontal axis 80; in particular, this cavity is in the form of a right cylinder of circular section about the axis 80; the distributor has a flange 81 that is fixed relative to an element 82 of the frame 32 of the apparatus.

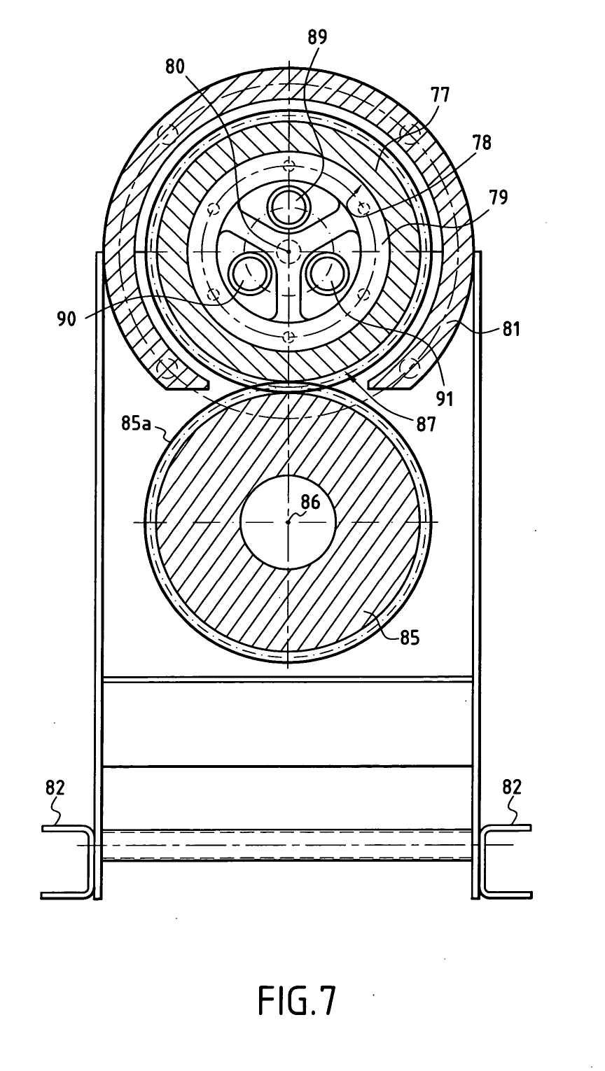

The frame 32 includes a bracket made up of bars 121, 122, and 123 that are connected to one another; the element 82 is a channel-section member (FIG. 7) enabling the members (such as 83 to 85) that it supports to slide relative to the bracket of the frame, along a horizontal axis 120 so as to make the distributor easier to clean and maintain.

This element 82 of the frame supports a motor 83, a gearbox 84 driven by the motor, and a gearwheel 85 mounted on an outlet shaft of the gearbox extending along an axis 86 parallel to the axis 80; the teeth 85a of the gearwheel 85 mesh with complementary teeth provided on the outside surface 87 of the ring 77; consequently, rotation of the gearwheel about the axis 86 under drive from the motor 83 causes the structure 77 and the three knives 88 fixed to the ring 77 and distributed at 120° intervals inside the cavity 79 to rotate about the axis 80.

The flange 81 has three orifices 89 to 91 for being connected respectively to each of three tubes 2, so that the tubes communicate with the cavity 79.

As shown in FIG. 7, these meat-outlet orifices 89 to 91 are centered on the vertices of an equilateral triangle whose center is placed on the axis 80 of rotation of the distributor, which axis corresponds to the longitudinal axis of the feed duct 76 (which is provided with a sealing gasket 92).

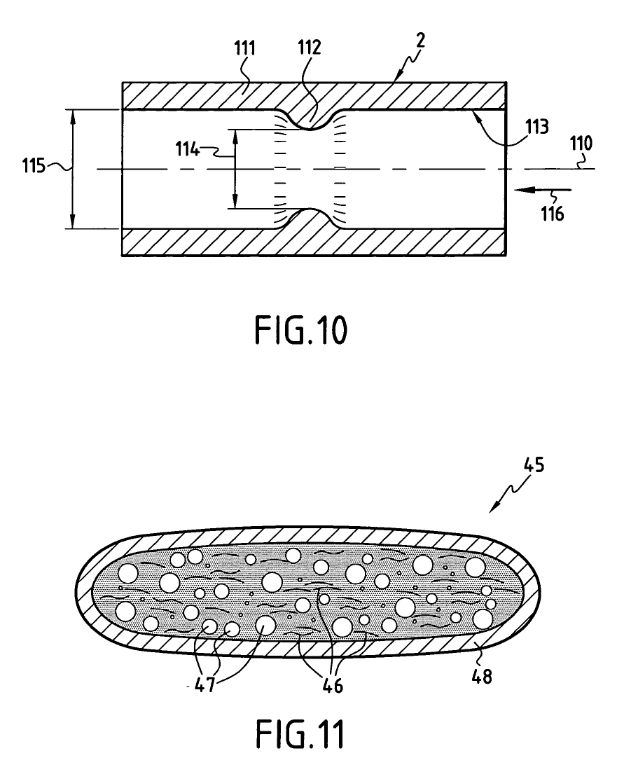

With reference to FIG. 10, the mold 2 is substantially tubular in shape about the axis 110; the wall 111 of the mold comprises an annular portion 112 which projects inwardly from the inside face 13 of the tube 2; this reduces the through diameter 114 in register with this internal annular projection relative to the diameter 115 of the mold upstream and/or downstream therefrom; this constriction of the mold serves to improve the cohesion of the meat traveling along arrow 116, after it has passed through this constriction, and enables at least a fraction of the fibers in the sausage meat to be oriented transversely.

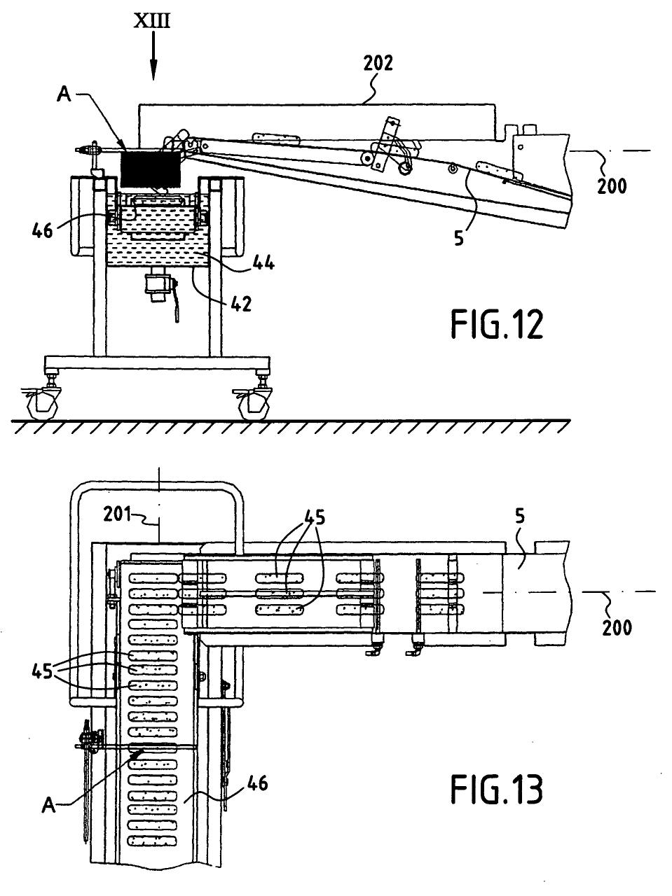

With reference to FIGS. 12 and 13, the conveyor 46 moving the sausages 45 through the second bath 44 extends along an axis 201 orthogonal to the longitudinal axis 200 of the conveyor 5; the sausages are delivered side by side in groups of three onto the conveyor 5 by the shaping device (reference 3 in FIGS. 1 and 2), drop off the end of the conveyor 5 onto the conveyor 46 in the bath 44 where they extend transversely to the axis 201. The end of the conveyor 5 is protected by a cover 202.

### EXAMPLES 1 to 3

A satisfactory first coating composition has been prepared by mixing the ingredients that appear in the table below with the specified proportions by weight:

| Ingredients | Example 1 | Example 2 | Example 3 |
|---|---|---|---|
| Water | 99% | 98% | 95% |
| Sodium | 1% | 0.5% | 2% |
| alginate | | | |
| Maltodextrin | — | 1% | 1% |
| Dextrose | — | 0.2% | 1% |
| Soybean | — | 0.3% | — |
| protein | | | |
| Wheat protein | — | — | 1% |
| (isolate) | | | |

Sugars other than dextrose could be used; the proportions of sugar and of maltodextrin in particular may be varied to a considerable extent; the first composition may have coloring agents, flavoring, herbs or spices added thereto; the sodium alginate powder may have anti-clumping agents added thereto in order to facilitate dispersion thereof in water.

### EXAMPLES 4 and 5

A satisfactory second composition has been prepared by mixing the ingredients that appear in the table below, with the specified proportions (by weight):

| Ingredients | Example 4 | Example 5 |
|---|---|---|
| Water | 93% | 83% |
| CaCl₂ | 7% | 1% |
| Saccharose | — | 10% |
| Pepper flavor | — | 5% |
| Soybean protein | — | 1% |
| (isolate) | | |

1-26. (canceled)

27. A method of making a food product comprising a base of molded sausage meat, purée , or paste coated in a film comprising a temperature-resistant gel such as a gel of calcium alginate, the method comprising the following successive steps:
forming a sausage of raw sausage meat, purée , or paste, by causing it to pass through a preferably tubular mold;
cutting the sausage into segments having ends that are preferably rounded;
moving the segments while coating them in a first composition containing sodium alginate, so as to cover the segments in a film of said first composition; and
putting the coated segments into contact, preferably by immersion, with a second composition containing a calcium salt so as to cause a calcium alginate gel to form around the segments of raw sausage meat, purée , or paste, preferably in a proportion by weight of 0.1% to 15% of calcium chloride in said second composition.

28. A method according to claim 27, wherein the coated products are drained and/or subjected to the action of an air jet after said first immersion in said composition and prior to being put into contact in said second composition in order to improve and homogenize the quality of the coating by the first composition.

29. A method according to claim 27, wherein a step is performed of sprinkling the segments with said first composition prior to immersing said segments in said first composition in a bath, the coating composition preferably being sprayed onto the product in distributed manner by forming a curtain, and more preferably said bath being fed by said curtain situated above said bath.

30. A method according to claim 27, wherein the proportion by weight of sodium alginate in said first composition is less than 2%, and preferably greater than 0.5%.

31. A method according to claim 27, wherein the sausage cutting tools are wetted with said first composition in order to lubricate them.

32. A method according to claim 27, wherein:
a food product based on fibrous meat is prepared by causing the meat to pass through a tubular mold to form a sausage; and
the sausage is caused to contract and then to expand so as to cause at least a fraction of the fibers in the fibrous meat to take up a transverse orientation.

33. A food product, in particular a sausage, comprising molded sausage meat or purée or paste coated by an alginate gel, obtained by a method according to claim 27.

34. A food product, in particular a sausage, comprising molded sausage meat or purée or paste coated in an alginate gel according to claim 33, the product comprising a proportion by weight of alginate in said coating lying in the range 0.5% to 2%.

35. A food product, in particular a sausage, comprising a sausage based on fibrous meat according to claim 33, the product including fibers of the fibrous meat that have been caused to take up a transverse orientation.

36. A composition for covering food products, comprising sodium alginate suitable for use in particular in a method according to claim 27, wherein the alginate is mixed with vegetable proteins and/or sugar and/or maltodextrin, and wherein the composition comprises a proportion by weight of sodium alginate in the composition lying in the range 0.5% to 2% and is in the form of a powder dispersed in an aqueous solution, said composition presenting fluidity that is sufficiently high to enable it to be transported under drive from a pump and/or to be sprayed for sprinkling the food products that are to be covered.

37. Apparatus for making food products from sausage meat (or purée , or paste), useful in particular for implementing a method according to claim 27, and for preparing products according to claim 33, the apparatus comprising a mold, means for introducing the meat into the mold, separator means serving to separate the meat into segments, and covering means for coating the meat in a gelling composition, in particular sodium alginate, wherein said covering means makes it possible to ensure that the sausage meat, purée , or paste is covered homogenously by said gelling composition.

38. Apparatus according to claim 37, wherein the covering means comprise a first vessel suitable for containing a first bath of a first composition for coating the products, and a second vessel suitable for containing a second bath of a second composition for coating the product, and means for transporting the segments serving to transport the segments from the first vessel to the second vessel, said transport means including means for causing the segments to drop, and preferably including drainage means for draining the coated products and/or air-injection means for homogenizing said covering.

39. Apparatus according to claim 37, including means (in particular ejection nozzles and/or transport channels) for introducing the gelling composition close to the moving separator means, preferably upstream therefrom, such that said composition contributes to limiting or avoiding adhesion of the meat on the moving separator means, to reducing friction between said moving means, and to facilitating regular shaping of the segments, and in particular of their ends.

40. Apparatus according to claim 37, including a plurality of tubular molds or nozzles enabling a plurality of meat sausages to be formed simultaneously, and a plurality of moving shaping and cutting means associated respectively with the tubular molds and enabling the sausages to be separated simultaneously into segments.

41. Apparatus according to claim 40, including means for distributing meat to the tubular molds, which meat is delivered via a meat feed orifice or duct orifice.

42. Apparatus according to claim 41, in which the meat distribution—or separation—means comprise a rotary structure defining a distribution cavity communicating with the tubular molds and also with the meat feed orifice.

43. Apparatus according to claim 42, in which the rotary structure presents an outside surface including rotary drive means, in particular an outside surface carrying teeth suitable for meshing with a drive member such as a gearwheel, and in which said rotary structure includes knives.

44. Apparatus according to claim 42, in which the distribution cavity presents symmetry about the axis of rotation of the rotary structure, in which the meat feed orifice is substantially centered on said axis of rotation, and in which the meat outlet orifices via which the distribution cavity communicates with the tubular molds extend symmetrically relative to said axis so as to encourage balanced distribution to the tubular molds of the meat delivered by the feed orifice.

45. Apparatus according to claim 40, in which the molds are parallel and in substantially horizontal alignment, so as to encourage segments of meat sausage to be delivered in line with a conveyor belt conveying the segments from the outlet of the separator means to the inlet of means for covering them by immersion.

46. Apparatus according to claim 37, in which the tubular mold(s) is/are fixed to a separator and shaping structure and to a meat pusher unit by removable connection means facilitating removal of the mold(s) for cleaning and/or exchange purposes.

47. Apparatus according to claim 40, comprising a frame supporting a structure for separating and shaping segments and also means for distributing meat to the tubular molds, in particular the rotary structure according to claim 42, which frame is adjustable or deformable, in particular telescopic, so as to make it easier to install and remove tubular molds and/or meat distribution means.

48. Apparatus according to claim 38, in which the moving separator means comprise two blades mounted to move in reciprocating translation on a structure (or head) for separating and shaping segments, the blades forming a guillotine, the end of each blade being shaped firstly to separate the continuous sausage into segments while the blades are in a first relative position in which they are closed, and secondly to shape, preferably round, an end of a segment of meat sausage while the blades are in a second relative position in which they are partially open.

49. Apparatus according to claim 48, in which each of the blades include a semicircular notch, the edge of the notch being tapered to form a cutting edge of chamfer of substantially spherical shape.

50. Apparatus according to claim 48, having two actuators for driving the two blades respectively, a control unit suitable for controlling the operation of the actuators and also for controlling the operation of the means for introducing meat into the mold, the control unit including means for individually controlling the two actuators and the introduction means so as to cause meat to pass through an orifice defined by the blades, when the tubular mold is in a position in which it is partially closed by the blades, thereby causing the section of a segment of sausage to decrease progressively in the vicinity of its end in order to facilitate shaping the ends of the segments.

51. Apparatus according to claim 37, including means for constricting the flow of sausage-shaped meat, suitable for modifying the orientation of fibers in the sausage of meat, for improving cohesion of the sausage of meat, and/or for improving its behavior during cooking.

52. Apparatus according to claim 37, including means for homogenizing the film or layer of the composition coating the product, which means are disposed between said first and second vessels defined in claim 38, said means preferably including nozzles for blowing air (or an appropriate gas) onto the products.
